(19) United States
(12) Patent Application Publication
(10) Pub. No.: US 2011/0011355 A1
(43) Pub. Date: Jan. 20, 2011

(54) Method and Device for Controlling Surface Temperatures on Internal Combustion Engines

(76) Inventor: John De la Hunt, Sparks, NV (US)

Correspondence Address: THORPE NORTH & WESTERN, LLP., P.O. Box 1219, SANDY, UT, 84091-1219, US

(21) Appl. No.: 12/502,908

(22) Filed: Jul. 14, 2009

(51) Int. Cl. F01P 7/02; F02F 1/10

(52) U.S. Cl. 123/41.05; 123/41.72

(57) ABSTRACT

A device for controlling surface temperatures on exposed surfaces of internal combustion engines to maintain all exposed engine surfaces below a predetermined maximum temperature includes a cooled enclosure enclosing components of the engine that normally have surfaces reaching temperatures above the predetermined maximum during normal operation of the engine. The cooled enclosure is sized to provide an air space between the enclosed engine surfaces and the exposed walls of the enclosure to slow heat transfer from the enclosed engine surfaces to the exposed enclosure walls, and the exposed enclosure walls are cooled, such as by circulation of cooling fluid through fluid circulation spaces within the walls, to maintain the exposed walls below the predetermined maximum. Cooling fluid for the cooled walls can come from the usual engine cooling system.

### BACKGROUND

1. Field of the Invention

The invention is in the field of internal combustion engine cooling systems and cooling devices for exhaust manifolds and superchargers on internal combustion engines.

2. State of the Art

Internal combustion engines are used for powering various types of vehicles and other equipment. However, various surfaces associated with internal combustion engines, such as engine exhaust manifolds, reach very high temperatures. These high temperature surfaces pose a fire danger, particularly since flammable fluids such as fuel and oil used in the engine could spill on the hot surfaces in the event of a fuel or oil leak. In some environments it is critical to eliminate or reduce as much as possible any potential fire hazards. Further, in some environments it is undesirable or dangerous to have any high temperature surfaces exposed to such environments. For example, diesel internal combustion engines are used in various pieces of equipment in underground mines. However, safety regulations for some mines in the United States, particularly for underground coal mines, restrict the presence of equipment producing exposed high temperature surfaces. Such safety regulations limit the exposed external temperature of equipment surfaces used in underground coal mines to 302 degrees F. The surface temperature of exhaust system components, such as exhaust manifolds, superchargers, and exhaust pipes on diesel engines are well above 302 degrees F. during normal operation of the engines. Therefore, mine operators must petition for special exemptions from the regulations when diesel equipment is to be used in underground coal mines. The granting of such special exemptions usually involve the implementation of special extra safety procedures in the mines to lessen the dangers associated with the presence of such high temperature surfaces.

### SUMMARY OF THE INVENTION

According to the invention, the surface temperature of all exposed parts of an internal combustion engine can be maintained below a critical temperature of about 302 degrees F. by providing a cooling enclosure or box around the portions or components of the engine where external surfaces normally reach higher temperatures. These portions and components are normally the exhaust manifold and the turbocharger of the engine, as well as the exhaust connection between the two. The cooling enclosure provides an air compartment directly around the exhaust manifold and the turbocharger and provides cooled enclosure walls forming the air compartment so as to maintain the exposed outer surfaces of the cooling enclosure below the critical temperature of 302 degrees F. The high temperature exhaust manifold and turbocharger are enclosed in the enclosure so they have no high temperature surfaces exposed to the outside mine environment. In this way, all exposed surfaces of internal combustion engines used in mining equipment in underground mines will remain below the critical safety temperature and will meet safety regulations. Such equipment can then be used in underground mines without mine operators having to apply for and receive waivers for use of such equipment.

The disclosed example embodiment of the invention is particularly directed to diesel engines which have the exhaust manifold and the turbocharger positioned on the same side of the engine block in close proximity to one another, such as in the Mercedes-Benz 900 series diesel engines. With this type of engine, a single cooling enclosure can be secured between the exhaust manifold and the engine block so as to position the exhaust manifold, the turbocharger, the exhaust connection between the two, as well as an exhaust conduit connecting the exhaust outlet of the turbocharger to the regular engine exhaust system exhaust pipe, all within the enclosure. The sides of the enclosure except the side that is positioned between the exhaust manifold and the engine block, which is not exposed to the mine environment around the engine, include a space therein for the circulation of cooling fluid. The cooling fluid keeps the exposed sides of the enclosure below the required 302 degrees F. An air space within the enclosure between the exhaust manifold and turbocharger and the enclosure walls insulates the manifold and turbocharger from the fluid cooled sides of the enclosure so as to keep the exhaust manifold and turbocharger at a desired high operating temperature while allowing the fluid cooling of the exposed sides of the enclosure to keep the exposed sides below the desired 302 degrees F. The cooling enclosure includes an easily removable exposed access panel which forms a wall of the enclosure and can be removed for access to the inside of the enclosure for installation and maintenance of the components positioned within the enclosure. Connections are provided for circulation of the cooling fluid through the access panel.

The exhaust conduit from the turbocharger connects to the usual exhaust pipe outside the enclosure to allow the exhaust to flow through a wall of the cooling enclosure. In most cases, at least a portion of the exhaust pipe outside the enclosure will also be cooled with a separate cooling jacket to keep the exposed surfaces around the exhaust pipe outside of the cooling enclosure below the 302 degree F. temperature. Further, in most cases, a flexible exhaust pipe connection or link is provided to prevent breakage of the exhaust pipe or exhaust pipe connections from engine movement and vibration and from expansion and contraction of the exhaust pipe. An air input to and an air output from the turbocharger also pass through walls of the cooling enclosure.

It has been found that creating a cooling fluid circulation circuit in parallel with the engine cooling circuit using the same radiator and cooling fluid normally used for cooling the engine is satisfactory to keep the exposed sides of the cooling enclosure below the critical temperature. Thus, the fluid used for cooling the sides of the cooling enclosure can be taken directly from the usual radiator used with such engines and be pumped through the sides of the cooling enclosure and then be added back into the fluid entering the radiator for cooling along with the cooling fluid from the engine. However, a separate fluid pump from the pump used for the engine cooling circuit is preferably used. The cooling fluid circuit for the cooling enclosure is separate from and does not connect to the engine parts such as the engine block or engine intake manifold. The only connections are at the inlet and outlet of the radiator.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is a pictorial view of the cooling system of the invention attached to an internal combustion engine and shown fragmentarily in broken lines;

FIG. 1A is a fragmentary enlargement of the front portion of FIG. 1 showing the mounting of the actuator for the turbocharger bypass valve on the cooling system of the invention;

FIG. 2 is an elevation of the rear end of the device of the invention (left side as shown in FIG. 1) taken on the line 2-2 of FIG. 1;

FIG. 3 is a transverse vertical section taken on the line 3-3 of FIG. 1;

FIG. 3A is an enlarged fragmentary vertical section of the connection between the turbocharger pressurized air outlet and the pressurized air outlet pipe of the cooling system of the invention;

FIG. 4 is a horizontal section taken on the line 4-4 of FIG. 1;

FIG. 4A is a fragmentary horizontal section of the left side of the system shown in FIG. 4 and showing a flexible exhaust pipe connection to the system;

FIG. 5 is a flow diagram for cooling fluid in a cooling system of the invention showing a schematic top plan view of the engine, radiator, and cooling system;

FIG. 6 is an alternate flow diagram for cooling fluid in a cooling system of the invention showing a schematic top plan view of the engine, radiator, and cooling system;

FIG. 7 is a fragmentary enlarged horizontal section similar to FIG. 4, showing the turbocharger in top plan view and showing details of the turbocharger bypass valve and control; and

FIG. 8 is a vertical section taken on the line 8-8 of FIG. 7.

Reference will now be made to the exemplary embodiments illustrated, and specific language will be used herein to describe the same. It will nevertheless be understood that no limitation of the scope of the invention is thereby intended.

### DETAILED DESCRIPTION OF THE ILLUSTRATED EMBODIMENTS

An example embodiment of the invention will be described and illustrated in connection with a Mercedes-Benz 900 series diesel engine which includes a turbocharger. However, the invention is not limited to use on such engines and may be used with various other internal combustion engines.

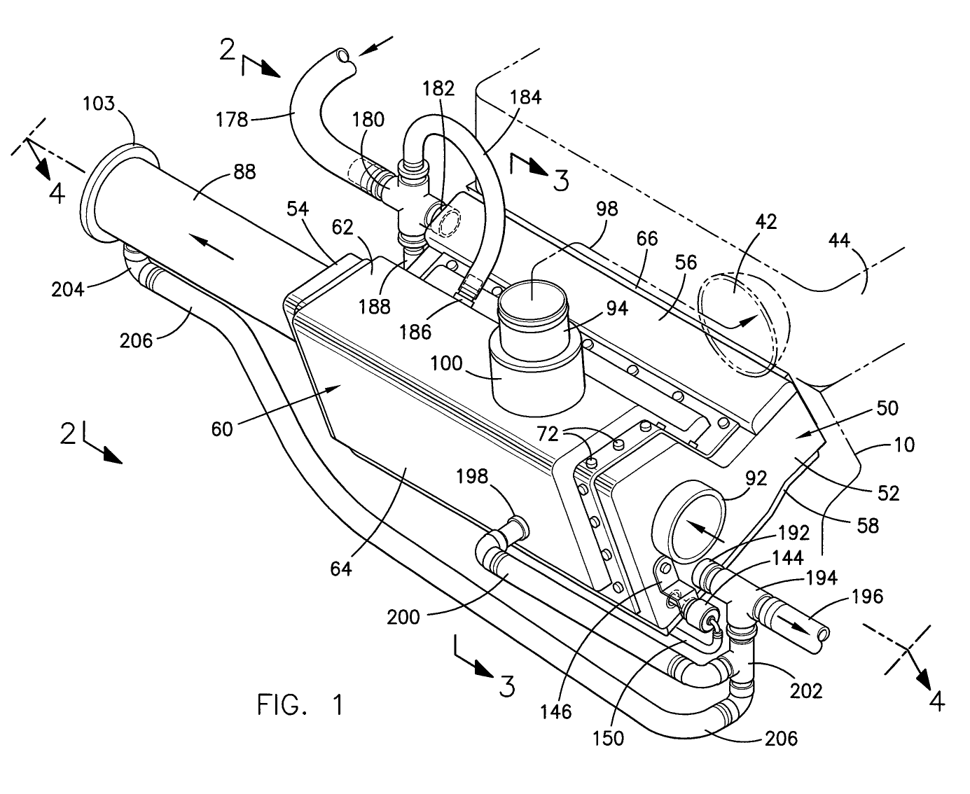

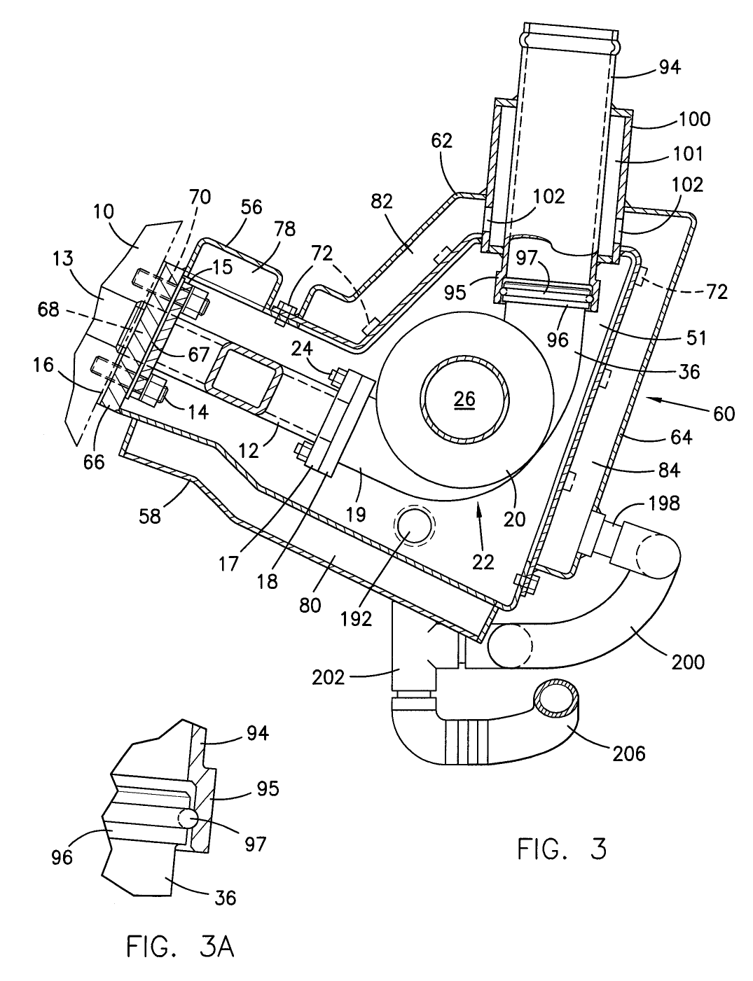

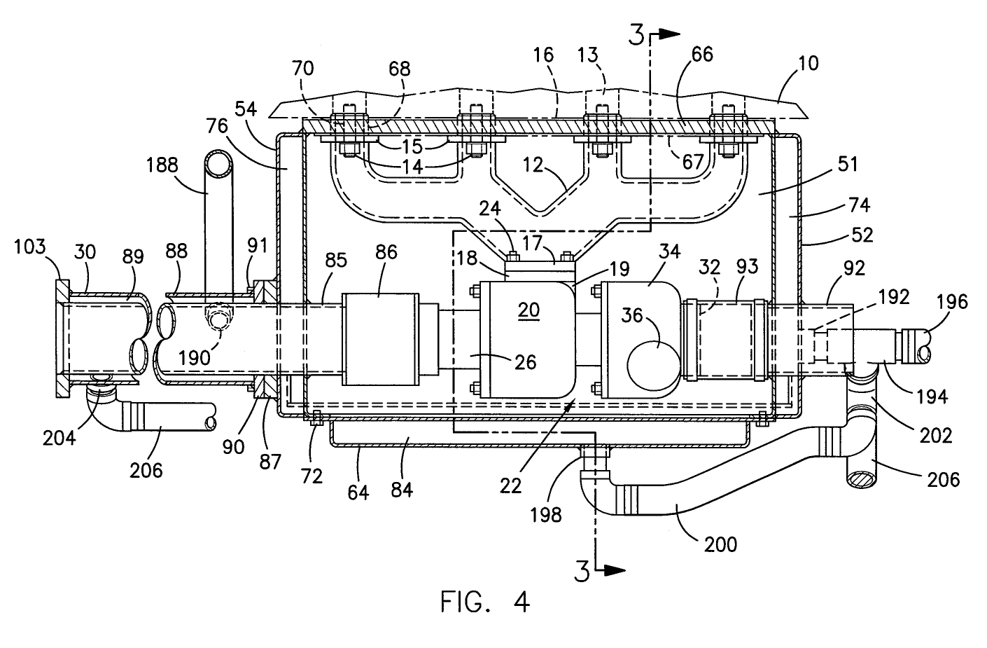

In the illustrated embodiment, the engine includes an engine block 10 with an exhaust manifold 12, FIGS. 3 and 4, attached to the engine block 10 in communication with usual exhaust port openings 13 in the engine block so that exhaust gas coming from the engine is directed into the exhaust manifold. The exhaust manifold 12 is attached to the engine block 10 by bolts 14 which extend in usual manner through the mounting flange 15 of the exhaust manifold into the engine block with a gasket 16 between the engine block and exhaust manifold. The exhaust manifold collects the exhaust gases from the engine and directs the exhaust gases through an exhaust manifold exhaust outlet connection flange 17 to the exhaust inlet connection flange 18 of the exhaust input 19 of the exhaust driven turbine portion 20 of a turbocharger 22. As illustrated, the turbocharger 22 is connected by bolts 24 to the exhaust manifold outlet flange 17 of the exhaust manifold 12 so is positioned adjacent to the exhaust manifold on the same side of the engine block. The exhaust gases from the exhaust outlet 26 of the exhaust driven turbine portion 20 of the turbocharger 22 are directed to exhaust pipe 30 which leads the exhaust from the turbocharger to the usual exhaust system components and then out to the environment outside the engine. When the engine is a diesel engine used in a mine, these usual exhaust system components can include a cooling tank (not shown), usually referred to as a “bubbler”, which cools the exhaust gases passing through the exhaust system, and a diesel particulate filter (not shown). In other uses, such exhaust system components may include a catalytic converter (not shown) and muffler (not shown). The turbocharger 22 has the usual air inlet 32 in compressor portion 34 of the turbocharger 22 which draws in air through an air conduit (not shown) from an air cleaner (not shown), and a turbocharger pressurized air outlet 36 through which pressurized air from the compressor portion 34 of the turbocharger flows for connection to the air intake 42, FIG. 1, of the intake manifold 44 of the engine. If desired, the pressurized intake air or charge from the turbocharger air outlet 36 can be passed through a charge cooler prior to entering air intake 42.

Because the exhaust manifold 12 and the exhaust driven turbine portion 20 of the turbocharger 22 are exposed directly to the hot exhaust gases from the engine, the exhaust manifold and the exhaust driven turbine portion of the turbocharger get very hot. Further, because the high temperatures of the exhaust add to the efficiency of the conversion of power from the exhaust gases to the turbocharger, it is generally not desirable to significantly cool the exhaust gases before entering the turbocharger. However, it is important when the engine is used in an environment where the temperature of exposed surfaces is limited, that the temperature of the exposed surfaces are controlled to remain under the critical temperature limit. For example, it is important when using the engine in an underground mine that the surfaces of the engine exposed to the environment in the mine remain below a critical temperature which, under current United States mine safety regulations, is 302 degrees F. The surfaces of the exhaust manifold and the exhaust driven turbine portion of the turbocharger reach much higher temperatures than 302 degree F. during normal operation of the engine. Therefore, the common practice when internal combustion engines are to be used in an underground mine is for the mine operator to petition for a modification of the normal safety regulations so that the engine with higher temperature components can be used in the mine. In such instances, the mine safety regulatory agency usually provides other special safety procedures to be put into effect in the mine to allow use of such engines.

In order to keep all exposed surfaces of the engine below the critical temperature, such as the critical temperature established by the mine safety regulations when the engine is used in an underground mine, the invention provides a cooled enclosure 50, FIG. 1, to enclose the hot exhaust manifold and turbocharger so that the hot surfaces of the exhaust manifold and turbocharger are not exposed to the environment around the engine. The walls of the cooled enclosure 50 are spaced from the exhaust manifold and the turbocharger to provide an air space 51, FIGS. 3-4 and 7, around the exhaust manifold and turbocharger that helps to insulate and slow the flow of heat from the heated components, i.e., the exhaust manifold and the turbocharger, to the walls of the enclosure. This substantially maintains the desired high temperature of the exhaust gases in the exhaust manifold through the turbine portion of the turbocharger. The exposed walls of the enclosure 50 are cooled to maintain the outside exposed surfaces of the walls of the enclosure below the desired 302 degrees F. In the embodiment shown, the walls have coolant circulation spaces for circulation of a cooling fluid through the coolant circulation spaces. The coolant circulation spaces in connected walls may be connected directly or through passages in the walls so that cooling fluid flows from a fluid inlet, through the coolant circulation spaces, to a fluid outlet. For separate walls, such as for exposed walls of a removable cover, separate cooling fluid inlets and outlets can be provided.

The cooled enclosure 50 of the illustrated embodiment includes a front cooled wall 52, a rear cooled wall 54, a cooled top portion wall 56, a cooled bottom wall 58, a cooled removable cover 60 which forms a cooled enclosure top wall portion 62 and a cooled enclosure outside side wall portion 64, and an uncooled inside side wall 66. Uncooled inside side wall 66 of enclosure 50 is positioned between the engine block 10 and the exhaust manifold 12, with gasket 16 between the engine block and wall 66 and gasket 67 between wall 66 and exhaust manifold 12, and attaches the cooled enclosure 50 to the engine by being sandwiched between the engine block 10 and exhaust manifold 12. Inside side wall 66 is uncooled because it is not exposed to the mine environment outside the engine. Inside side wall 66 also includes openings 68 corresponding to the exhaust ports 13 in the engine block to allow flow of exhaust gases from the engine block exhaust ports through the enclosure inside side wall openings 68 into the exhaust manifold 12, and openings 70 through which bolts 14 extend in attaching the exhaust manifold to the engine block. The cooled removable cover 60 is provided to allow access to the inside of the cooled enclosure for installation of the enclosure and components enclosed within the enclosure and for access to such components for maintenance. Cooled removable cover 60 is attached to cooled enclosure 50 as part of the cooled enclosure 50 by bolts 72.

The cooled enclosure walls include cooling fluid circulation spaces through which cooling fluid can be circulated to cool the exposed walls. Also, removable enclosure cover 60 includes cooling fluid circulation spaces therein through which cooling fluid can be circulated for cooling the exposed exterior surfaces of the cover. Thus, front cooled wall 52 includes fluid circulation space 74, see FIG. 4, rear cooled wall 54 includes fluid circulation space 76, cooled top portion wall 56 includes fluid circulation space 78, see FIG. 3, and cooled bottom wall 58 includes fluid circulation space 80. Cooled removable cover 60 includes fluid circulation space 82 in cooled enclosure top wall portion 62 and fluid circulation space 84 in cooled enclosure outside side wall portion 64. As indicated, inside side wall 66 is uncooled so does not include a fluid circulation space.

With cooled enclosure 50 enclosing the exhaust manifold 12 and the turbocharger 22, provision has to be made for turbocharger exhaust outlet 26 to be connected to exhaust pipe 30, for turbocharger air inlet 32 to be connected to a source of inlet air, and for turbocharger pressurized air outlet 36 to be connected to engine air intake 42. As shown in FIG. 4, an exhaust connection pipe 85 is connected to the exhaust outlet 26 of the exhaust driven turbine portion 20 of the turbocharger 22 by a flexible connector 86 provided to compensate for expansion and contraction of the exhaust system components within the enclosure and of the enclosure in relation to the exhaust system components. As used herein, a flexible connector will not only bend, but will also extend and contract. Exhaust connection pipe 85 terminates in cooled enclosure exhaust pipe connector flange 87 positioned, such as by welding, on the outside of rear enclosure wall 54. Cooled enclosure exhaust pipe connector flange 87 provides for connection of exhaust pipe 30, which will usually include an exhaust pipe jacket 88 providing a cooling fluid circulation space 89 between the exhaust pipe 30 and exhaust pipe jacket 88, by means of mating exhaust pipe connecting flange 90 which is secured to cooled enclosure exhaust pipe connector flange 87 by bolts 91. A gasket (not shown) will usually be sandwiched between the respective connector flanges to seal the connection.

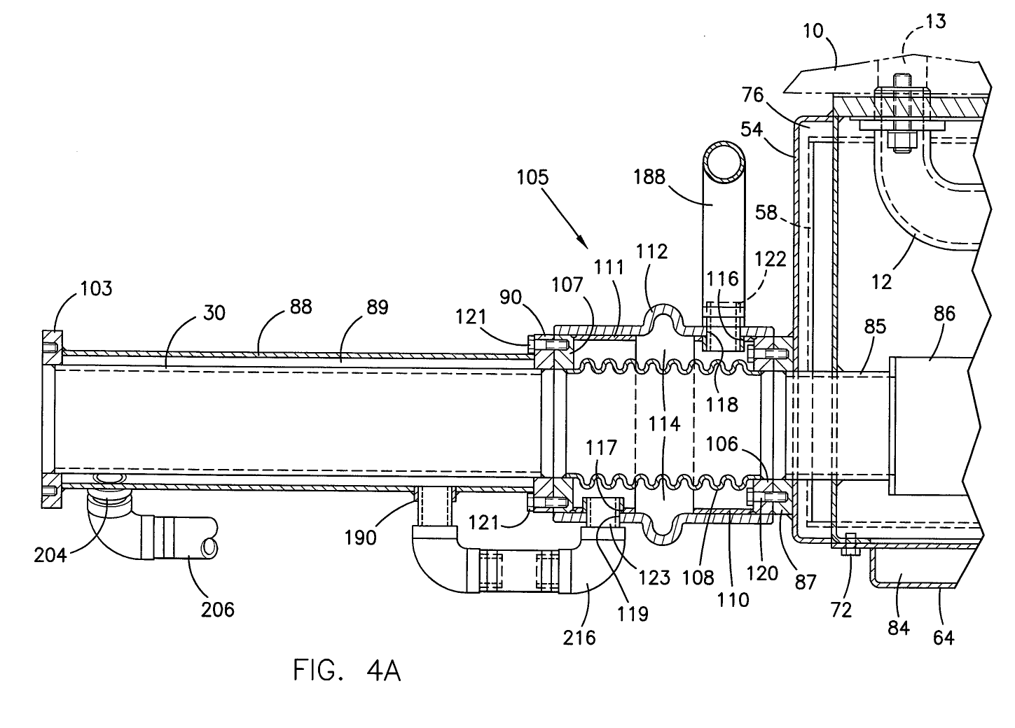

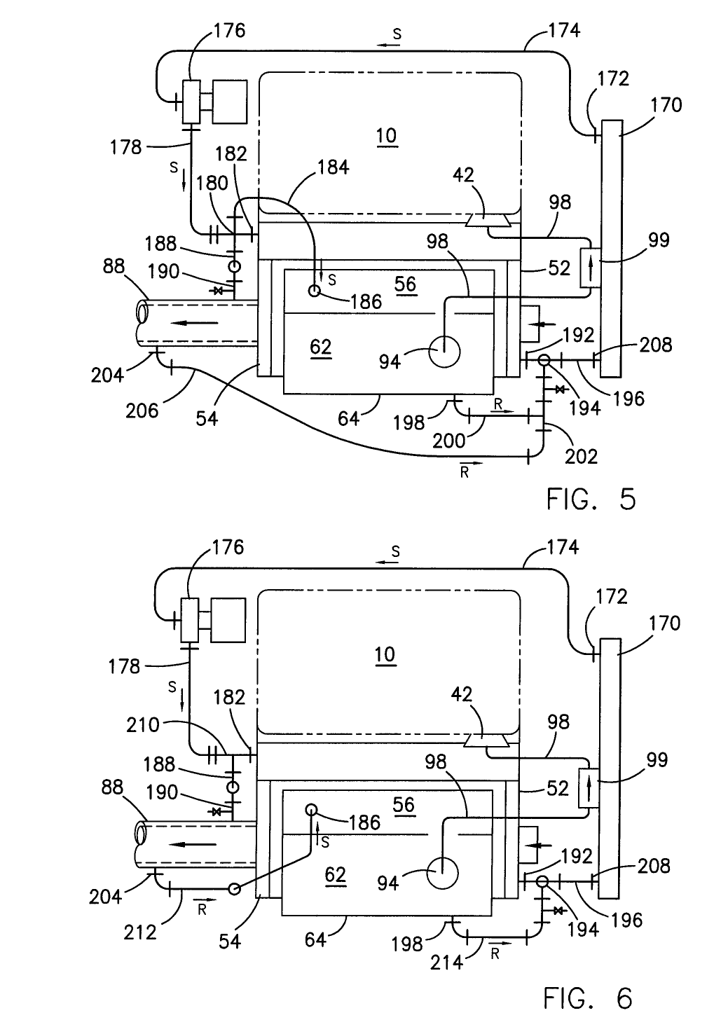

An air inlet pipe 92 is connected to turbocharger air inlet 32 by flexible connector 93. Inlet pipe 92 extends through the front wall 52 of the enclosure and is sized to allow a hose (not shown) to be slide onto and secured to the end of the air inlet pipe 92 that extends from the front wall. As previously indicated, the hose will connect the air inlet pipe and the turbocharger air inlet with a source of air, usually a standard air cleaner. Since the source of inlet air will generally be from the environment around the engine which is relatively cool air, the flexible connector 93 can generally be a rubber coupling rather than a high temperature coupling as is needed for flexible exhaust coupling 86. The pressurized air from the turbocharger is expelled through pressurized air outlet 36 and outlet pipe 94, FIG. 3, which extends through the enclosure top wall portion 62 of the cooled enclosure 50, which, in the embodiment shown, is through the removable enclosure cover 60. In order to allow easy opening and closing of the cover, it is preferred to provide a sliding connection between the turbocharger outlet 36 and the pressurized air outlet pipe 94. This can be accomplished by providing a receiving sleeve 95 on the end of outlet pipe 94 which fits over the end 96 of air outlet 36 when the cover 60 is in place on the enclosure. An O-ring 97 in the end 96 of air outlet 36 seals the connection, see FIGS. 3 and 3A. A hose or other conduit, indicated schematically in FIGS. 1, 5, and 6 as 98, is connected to the end of outlet pipe 94 that projects from the enclosure, and directs the pressurized air from the turbocharger to the engine air intake 42 of the intake manifold 44. As shown schematically in FIGS. 5 and 6, a standard charge cooler 99 to cool the pressurized air or charge prior to entering the intake manifold can be provided in hose 98. The charge cooler will generally be physically located behind the engine cooling system radiator as shown schematically in FIGS. 5 and 6.

While the illustrated embodiment shows pressurized air or charge outlet pipe 94 extending through a wall of the removable enclosure cover 60 so that a sliding connection is provided between the pressurized air outlet pipe 94 which is secured in the removable cover and the turbine pressurized air outlet 36 to allow the cover 60 to be easily positioned and removed, the pressurized air outlet pipe 94 could be positioned to extend through a non-removable wall of the enclosure 50 so is not removed with the removable cover 60. In such case, the turbocharger pressurized air outlet 36 can be directly connected to the pressurized air outlet pipe 94 through a flexible coupling and/or pipe connector. Further, if desired, the enclosure can be configured so that a non-removable wall of the enclosure 50 is positioned to have pressurized air outlet pipe 94 located to be easily connected to turbocharger pressurized air outlet 36, such as extending directly over turbocharger pressurized air outlet 36, with removable cover 60 reconfigured to allow such positioning of the non-removable enclosure wall.

Since the outlet air from the turbocharger has been compressed, it will generally be of a higher temperature than when drawn into the turbocharger. In many cases, with the heat generated by compression and gained from the temperature of the turbocharger, the air will be above the critical temperature. A cooler 100 built into cooled enclosure 50 is provided to cool outlet pipe 94 and, to some degree, the pressurized air flowing therethrough so that the portion of the pressure outlet pipe 94 extending from the enclosure will be maintained below the critical temperature. As shown in FIG. 3, cooler 100 built into cooling enclosure 50 includes cooling fluid circulation space 101 in communication with cooling fluid circulation space 82 in cooled enclosure top wall portion 62 through ports 102. With cooling fluid circulation space 101, the circulating cooling fluid will cool outlet pipe 94. The cooler 100 has been found satisfactory for cooling pipe 94 to below the critical temperature with air pressurized up to at least about ten PSI. However, for very high pressures up to between about thirty and forty PSI, cooler 100 may not cool pipe 94 below the critical temperature, which generally will mean that the air conduit extending from pipe 94 will need cooling as it extends to the charge cooler. For this cooling, a jacketed conduit (not shown), similar to the jacketed exhaust pipe 30 with jacket 88, will be provided with cooling fluid circulated therealong.

Since the exhaust gases exiting the exhaust connection pipe 85 are not substantially cooled in the cooled enclosure 50, such gases remain very hot as they leave cooled enclosure 50. This means that the exhaust pipe 30 extending from cooled enclosure 50 will be heated by the high temperature exhaust gases to a high temperature, usually well above the critical temperature, during operation of the engine. Therefore, exhaust pipe 30 extending from the cooled enclosure 50 is a high temperature surface that also needs to be enclosed so it is not an exposed surface. For this purpose, exhaust pipe 30 includes jacket 88 which surrounds exhaust pipe 30 along enough of its length to cool exhaust pipe 30 to below the critical temperature of 302 degrees F. Thus, exhaust pipe 30 will be at a temperature below 302 degrees F. when it emerges from jacket 88. The downstream end of exhaust pipe 30 where it extends from jacket 88 has a downstream connecting flange 103 similar to connecting flange 90 at the head end of exhaust pipe 30 where it connects to enclosure exhaust pipe connector flange 87. Depending upon the configuration of the exhaust system, this downstream end flange 103 can connect to the bubbler, which cools the exhaust gas, to a length of unjacketed exhaust pipe if the exhaust pipe has been sufficiently cooled, or to a further length of jacketed exhaust pipe if additional cooling is needed. Jacket 88 forms cooling fluid circulation space 89 around exhaust pipe 30 so that with cooling fluid circulated in fluid circulation space 89, the exposed wall of jacket 88 remains below 302 degrees F.

In equipment where both the internal combustion engine and exhaust system components are mounted to a frame or chassis, the engine will generally be mounted through rubber mounting blocks so that the engine can vibrate and move with respect to the frame or chassis. Relative movement between the engine and the frame or chassis occurs when the engine applies torque to the drive system of a vehicle powered by the engine. If the exhaust system is also mounted to the frame or chassis, it will usually be necessary to provide a flexible connection between the engine and the exhaust system or somewhere in the exhaust system to allow relative movement between the engine and exhaust system so that movement of the engine relative to the frame or chassis will not cause breakage in the exhaust system. This potential for breakage has been found to be a particular problem where exhaust system cooling is provided. In the present system, the cooled enclosure 50 is substantially rigidly mounted to the engine so will vibrate and move with the engine. Enclosure exhaust pipe connecting flange 87 is rigidly mounted to the cooled enclosure 50 so will also vibrate and move with the engine. The exhaust pipe 30 and jacket 88 are rigidly mounted the exhaust pipe head end exhaust pipe connecting flange 90. When exhaust pipe connecting flange 90 is connected directly to enclosure exhaust pipe connecting flange 87, this connection will also vibrate and move with the engine. If the exhaust pipe or other components of the exhaust system, such as the bubbler, are connected to the frame or chassis, even where such connections are flexible connections, the relative movement of the engine with respect to the frame or chassis can result in breakage of the exhaust pipe and jacket or other exhaust system components or connections. It is therefore advisable with the present system to provide a flexible connection between the cooled enclosure and the exhaust system, or somewhere in the exhaust system.

FIG. 4A shows a flexible connector 105 of the invention usable with the cooled exhaust system of the current invention to allow relative movement of the cooled exhaust system with respect to the cooled enclosure 50 of the invention mounted to the engine. In the embodiment of FIG. 4A, the flexible connector 105 is connected between the cooled enclosure 50 and the exhaust system, although it could be mounted somewhere in the exhaust system itself. As shown, flexible connector 105 includes connector end mounting flanges 106 and 107 at opposite ends of the connector 105, with a high temperature bellows type flexible pipe 108 extending between the mounting flanges. High temperature flexible pipe 108 forms an exhaust pipe within the connector and allows relative movement between the respective end mounting flanges 106 and 107. Rigid sleeve 110 is connected, such as by welding, around the outside edge of mounting flange 106 and rigid sleeve 111 is connected, such as by welding, around the outside edge of mounting flange 107. Both rigid sleeves 110 and 111 extend toward one another toward the center of the connector. An elastomeric flexible sleeve 112 fits snugly over and between rigid sleeves 110 and 111 to form a fluid tight cooling fluid circulation space 114 in the connector 105 between flexible pipe 108 and outside flexible sleeve 112. Flexible sleeve 112 can be slid into assembled position shown over the rigid sleeves 110 and 111 and mounting flanges 106 and 107. While not shown, clamps can be tightened around each end of flexible sleeve 112 to ensure a fluid tight seal. Flexible sleeve 112 will flex with flexible pipe 108. Rigid sleeve 110 has a threaded cooling fluid fluid hole 116 extending therethrough while rigid sleeve 111 has a similar coolant fluid threaded hole 117 extending therethrough. If, when installed, the ends of flexible sleeve 112 cover cooling fluid holes 118 and 119, flexible sleeve 112 will be provided with holes 118 and 119 which align with threaded holes 116 and 117. Alternately, flexible sleeve 112 can be made short enough so that when in assembled position on sleeves 110 and 111, the ends of flexible sleeve 112 do not cover holes 116 and 117.

Flexible connector 105 is installed by connecting flexible connector mounting flange 106 to cooled enclosure exhaust system mounting flange 87 with bolts 120. Flexible connector connecting mounting flange 107 is connected to exhaust pipe mounting flange 90 by bolts 121. Flexible sleeve 112 can be placed over exhaust pipe sleeve 88 during installation of the connector 105 between the cooled enclosure and the exhaust system, and slid into assembled position over the rigid sleeves 110 and 111 and mounting flanges 106 and 107 once the connector 105 is secured in position. Once flexible sleeve 112 is in position so that holes 118 and 119 are aligned with holes 116 and 117, respectively, hose connection fittings 122 and 123 can be screwed into holes 116 and 117. Fitting 122 provides a connection for a cooling fluid inlet hose, while fitting 123 provides a connection for cooling fluid outlet hose.

While FIG. 4A shows flexible connector 105 installed between the cooled enclosure 50 and the exhaust pipe 30, flexible connector 105 could be positioned in the exhaust system, such as between exhaust pipe sections or between the exhaust pipe and other exhaust system components such as between the exhaust pipe and the bubbler. Since the jacketed exhaust pipe as shown has a mounting flange 103 at its end, the flexible connector 105 can be connected to such exhaust pipe mounting flange 103 similarly to the mounting to enclosure exhaust system mounting flange 87 as described above. The important thing is that the flexible connector be inserted into the exhaust system between the cooled enclosure that is connected to the engine and any connection of the exhaust system to a frame or chassis. If there is no connection between the exhaust system and a frame or chassis, there probably will be no need for a flexible connection between the cooled enclosure and the exhaust system. Further, as previously indicated, flexible connector 105 is flexible in all directions, including the longitudinal direction of the connector. To provide the needed flexibility, the flexible connector will usually be somewhere between about nine inches and six feet long. The minimum length should be at least two and one half times the exhaust pipe diameter.

The cooled flexible connector 105 developed for use in the current invention for connecting the exhaust system to the enclosure or for connecting portions of the exhaust system together to absorb movement and vibration between the enclosure attached to the engine and the exhaust system can be used in any situation where conduits for heated fluid need to be connected, where the connection needs to be cooled, and where relative movement between parts of the system need to be provided for. Thus, a cooled connector constructed as described above to include a flexible high temperature pipe having opposite pipe ends, a flange sealingly connected to each of the opposite pipe ends and extending radially outwardly thereform to an outside perimeter edge, an end sleeve sealingly connected to the outside perimeter edge of each flange to provide opposite end sleeves that extend from the flange toward the opposite sleeve, and a flexible outside sleeve extending between and sealingly connected to each of the opposite end sleeves to form a flexible connector having a cooling fluid circulation space therein between the flexible high temperature pipe and the flexible outside sleeve can be used in various other equipment, industrial facilities, processing systems, etc.

Most turbochargers used with internal combustion engines include a bypass valve in the turbine portion 20 of the turbocharger which, when operated, opens a bypass for a portion of the exhaust gases to bypass the turbine to reduce the pressure of the input air or charge generated by the compressor portion 34 of the turbocharger. A bypass valve actuator is mounted on the outside of the turbocharger exposed to the environment normally surrounding the engine and has a connection to the compressor portion 34 of the turbocharger to operate the bypass valve in response to the pressure of the input or charge air generated by the compressor portion of the turbocharger. This is a safety device for the engine. This safety device must remain on turbochargers that include this valve. However, with the cooled enclosure 50 of the invention surrounding the turbocharger when the system of the invention is used, the interior of the cooled enclosure, which becomes the environment around the turbocharger, is of higher temperature than would be the case without use of the invention. The bypass valve actuator should not be subjected to this higher temperature environment. Therefore, to ensure proper operation of the bypass valve actuator, it should be moved to the outside of the cooled enclosure 50 of the invention when the invention is installed to enclose a turbocharger on an engine.

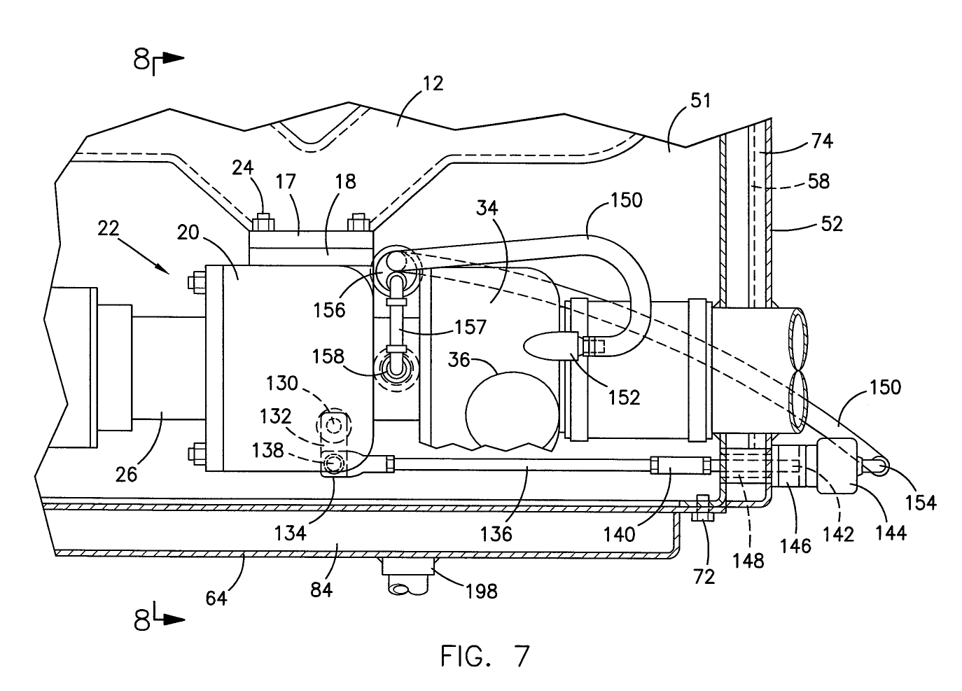

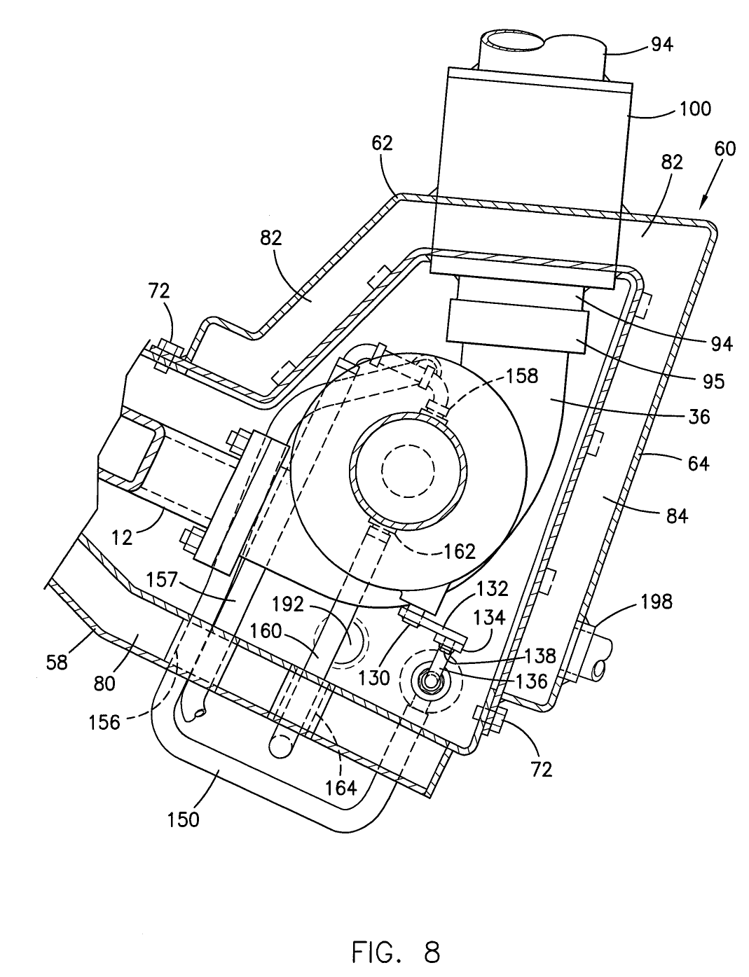

The bypass valve is generally located completely within the turbine portion of the turbocharger so is not visible in any of the Figs. An operating shaft from the bypass valve will generally extend through a wall of the turbocharger so that rotation of the operating shaft will operate the bypass valve. FIGS. 7 and 8 show a typical bypass valve operating shaft 130 extending from the turbine portion 20 of turbocharger 22, and having a typical bypass valve operating lever 132 extending from the operating shaft 130. The end 134 of an operating arm 136 is pivotally attached to the end of operating lever 132 by pivot pin 138. Operating arm 136 extends to attachment through adjustable attachment sleeve 140 to actuator arm 142 extending from bypass valve actuator 144 which has been moved from its normal attachment to turbocharger 22 to attachment to the outside of cooled enclosure front wall 52, FIGS. 1, 7 and 8. Bracket 146 attaches bypass valve actuator 144 to cooled enclosure front wall 52. Actuator arm 142 extends from bypass valve actuator 144 through opening 148 which extends through cooled enclosure front wall 52 and front wall cooling fluid circulation space 74 to attachment to adjustable attachment sleeve 140. Opening 148 does not have to be sealed around actuator arm 142 as it has been found that there is no substantial flow of hot air from inside the cooled enclosure through the opening 148. A pressure line 150 extends from pressure line connector 152 on the compressor portion 34 of turbocharger 22 to pressure inlet 154 of the bypass valve actuator 144. Pressure line 150 transmits the pressure of the pressurized intake or charge air from inside the compressor portion 34 to the bypass valve actuator 144 so that actuator arm 142 will move to extend further from the bypass valve actuator 144 when excessive pressure builds up in the compressor. The extension of actuator arm 142 moves operating arm 136 and operating lever 132 to rotate bypass valve operating shaft 130 and operate the bypass valve in the turbine to reduce the power produced by the turbine and reduce the pressure produced by the compressor. This is the normal operation of the bypass valve actuator 144 and the bypass valve. Pressure line 150 extends from inside cooling enclosure 50 to outside cooling enclosure 50 through opening 156 through cooled enclosure bottom wall 58 and cooling fluid circulation space 80, FIG. 8. The normal turbocharger oil inlet hose 157 extends from an oil pump (not shown) through opening 156 to connect to turbocharger oil inlet fitting 158. Oil outlet hose 160 extends from turbocharger oil outlet 162 through opening 164 through cooled enclosure bottom wall 58 and cooling fluid circulation space 80. Openings 156 and 164 do not have to be sealed around the hoses as, again, it has been found that there is no substantial flow of hot air from inside the cooled enclosure through the openings 156 and 164. While the arrangement and location of the bypass valve and control may vary from turbocharger to turbocharger, the illustrated bypass control described above is typical and the illustrated arrangement can be easily modified as necessary for any particular turbocharger.

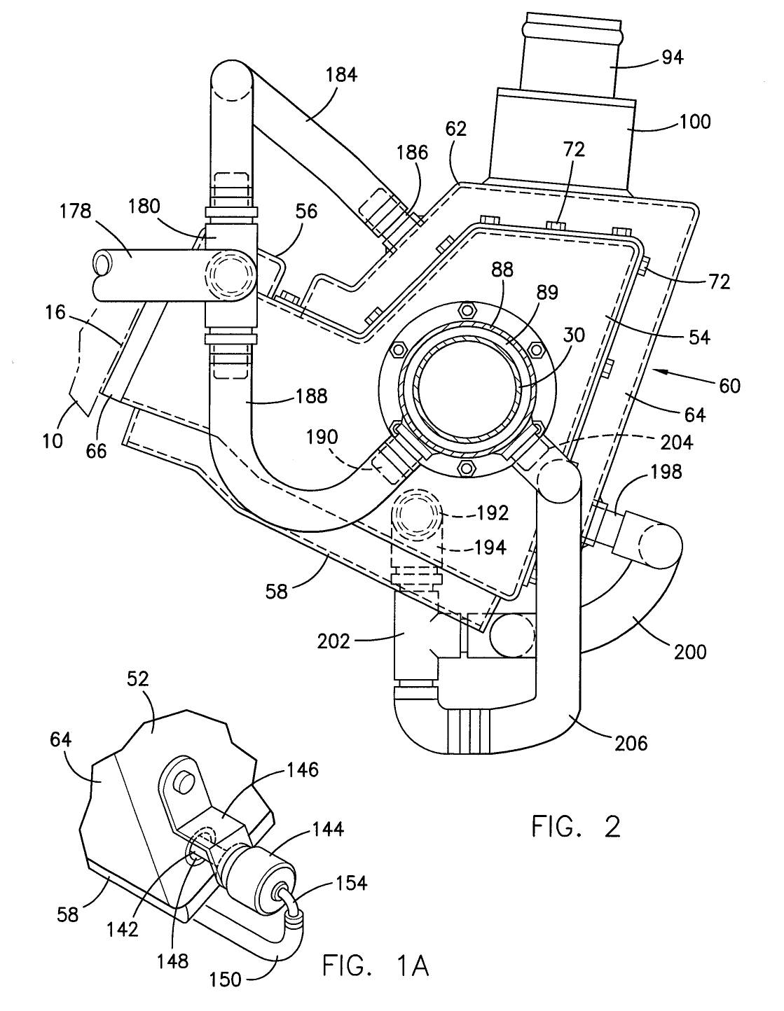

While various flow patterns and connections for cooling fluid can be provided, the illustrated embodiment includes a recirculation cooling fluid circuit which includes a cooling radiator 170 (FIGS. 5 and 6) which will generally be the same radiator as the cooling radiator of the usual engine cooling system. Cooled cooling fluid from the radiator outlet 172 (at the bottom left side of the radiator) flows into fluid hose 174 and is pumped by fluid pump 176 into fluid hose 178 to cooling fluid manifold 180 (FIGS. 1, 2, and 5). Cooling fluid manifold 180 splits the cooling fluid into three streams, a first stream flowing into rear wall cooling fluid circulation space 76 through fitting 182 extending into rear wall 54, a second stream flowing into fluid hose 184 and through fitting 186 into cooling fluid circulation space 82 in enclosure top wall portion 62 of removable cover 60, and a third stream flowing into fluid hose 188 and through fitting 190 into cooling fluid circulation space 89 between exhaust pipe 30 and water jacket 88. Rear wall cooling fluid circulation space 76, FIG. 4, is in fluid communication with top portion wall cooling fluid circulation space 78, FIG. 3, and bottom wall cooling fluid circulation space 80 which, in turn, are in fluid communication with front wall cooling fluid circulation space 74, FIG. 4. Thus, cooling fluid flows through rear wall cooling fluid circulation space 76 into top portion wall cooling fluid circulation space 78 and bottom wall cooling fluid circulation space 80 and then into front wall cooling fluid circulation space 74. From front wall cooling fluid circulation space 74, the cooling fluid flows through fitting 192, FIGS. 1, 4, and 5, into T fitting 194 and into cooling fluid return flow line 196. Cooling fluid circulation space 82 in enclosure top wall portion 62, FIG. 3, of removable cover 60 is in fluid communication with cooling fluid circulation space 84 of front side wall portion 64 of removable cover 60 so that cooling fluid flows from cooling fluid circulation space 82, FIG. 3, into cooling fluid circulation space 84. From cooling fluid circulation space 84, cooling fluid flows through fitting 198 into fluid hose 200 and into T fitting 202 which feeds into T fitting 194 and cooling fluid return flow line 196. Cooling fluid in cooling fluid circulation space 89 between exhaust pipe 30 and jacket 88 flows from fluid inlet fitting 190 in fluid circulation space 89 along exhaust pipe 30 to fluid outlet fitting 204 into fluid hose 206 to fluid T fitting 202 where it combines with cooling fluid from the removable cover 60 and then flows into T fitting 194 to combine with the cooling fluid from enclosure front end cooling fluid circulation space 74 to flow into return flow line 196. Fluid return flow line 196 connects to radiator inlet 208 of radiator 170 (at the top right side of the radiator) where the fluid joins the return cooling fluid from the engine cooling system for flow through radiator 170 and recirculation.

FIG. 6 shows a slightly different flow pattern where the incoming cooling fluid in fluid tube 178 to the system of the invention is divided into two flow streams rather than three flow streams. Here cooling fluid from fluid tube 178 is split into two flow streams by T fitting 210. One stream flows into rear wall cooling fluid circulation space 76 through fitting 182 extending into rear wall 54, while the second stream flows into fluid hose 188 and through fitting 190 into cooling fluid circulation space 89 between exhaust pipe 30 and water jacket 88. After cooling exhaust pipe 30, the cooling fluid from cooling fluid space 89 flows through fitting 204 and fluid hose 212 to fitting 186 and into cooling fluid circulation space 82 in top portion 62 of removable cover 60. The cooling fluid flows through cooling fluid circulation space 82 into cooling fluid circulation space 84 and exits the front side wall 64 of cover 60 at fitting 198. The cooling fluid then flows through hose 214 into T fitting 194 to join the fluid from the front wall of the enclosure from fitting 192 for return to the radiator through cooling fluid return flow line 196. Various other flow patterns can also be used. Further, separate radiators could be used in instances where the engine cooling system radiator does not have the capacity to cool the fluid from both fluid circuits.

When a cooled flexible exhaust system connector 105 as shown in FIG. 4A is used, if connected between the cooling enclosure 50 and the exhaust pipe as shown in FIG. 4A, hose 188 from the cooling fluid manifold 180 of FIG. 5 or the cooling fluid supply T fitting 210 of FIG. 6 will connect to coolant fluid inlet hose connection fitting 122, FIG. 4A, and a coolant fluid connecting hose 216 will connect cooling fluid outlet hose connection fitting 123 from connector 105 to exhaust pipe coolant fluid inlet fitting 190. Cooling fluid will flow through flexible connector cooling fluid circulation space 114 and then into the jacketed exhaust pipe fluid circulation space 89. Other cooling fluid connections will be made for other connections of the flexible exhaust system connector 105. For example, if the cooled flexible exhaust system connector 105 is connected to the connecting flange 103 at the downstream end of the exhaust pipe, cooling fluid connections are made from outlet fitting 204 of the exhaust system to flexible connector inlet fitting 122 and flexible connector outlet fitting 123 will connect to either fluid return hose 206, or, if additional cooled exhaust pipe sections are connected to the connector, to the inlet of an additional cooled exhaust pipe section.

Where additional high temperatures surfaces are present in an engine, additional cooled enclosures can be positioned over the high temperatures surfaces to enclose them and provide a cooled exposed surface. If the exhaust manifold and turbocharger are located on different sides of the engine or are otherwise separated a distance apart, separate cooled enclosures can be provided for the exhaust manifold and the turbocharger, as well as the connecting exhaust conduit.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A device for controlling the maximum temperature of exposed surfaces on internal combustion engines having an exhaust manifold and associated components with exposed surfaces which normally reach temperatures above the maximum temperature during normal operation of the engine, comprising:
walls forming an enclosure for the engine exhaust manifold and associated components having normal operating temperatures above the predetermined maximum temperature so that said exhaust manifold and associated components are completely enclosed within the enclosure and are not exposed to the environment surrounding the engine, at least some of said walls forming the enclosure having exposed surfaces;
means for securing the enclosure around the exhaust manifold and associated components; and
means for cooling the exposed surfaces of the enclosure walls having exposed surfaces so that the temperature of the exposed surfaces are below the predetermined maximum temperature.

2. A device for controlling the maximum temperature of exposed surfaces on internal combustion engines according to claim 1, wherein the means for cooling the exposed surfaces of the enclosure walls having exposed surfaces include fluid circulation spaces within the walls having exposed surfaces for circulation of cooling fluid, and an enclosure fluid circulation system for circulating cooling fluid through the fluid circulation spaces in the walls.

3. A device for controlling the maximum temperature of exposed surfaces on internal combustion engines according to claim 2, wherein the engine includes an engine cooling system having engine cooling fluid and a radiator with a fluid inlet and a fluid outlet for the cooling engine cooling fluid, and wherein the enclosure fluid circulation system includes a fluid pump for pumping engine cooling fluid from the radiator outlet through the fluid circulation spaces within the walls having exposed surfaces and back into the radiator inlet.

4. A device for controlling the maximum temperature of exposed surfaces on internal combustion engines according to claim 1, wherein the engine has an engine block, and wherein the means for securing the enclosure around the exhaust manifold and associated components is a wall of the enclosure adapted to be positioned between the exhaust manifold and the engine block.

5. A device for controlling the maximum temperature of exposed surfaces on internal combustion engines according to claim 4, wherein the wall of the enclosure adapted to be positioned between the exhaust manifold and the engine has no exposed surfaces.

6. A device for controlling the maximum temperature of exposed surfaces on internal combustion engines according to claim 1, wherein the walls forming the enclosure include a removable panel which can be removed to provide access to the exhaust manifold and associated components inside the enclosure.

7. A device for controlling the maximum temperature of exposed surfaces on internal combustion engines according to claim 6, wherein the exhaust manifold and associated components inside the enclosure include a turbocharger.

8. A device for controlling the maximum temperature of exposed surfaces on internal combustion engines according to claim 7, additionally including an exhaust pipe connected to the enclosure and in flow communication with the exhaust manifold and associated components for discharging exhaust gas from the exhaust manifold and associated components into the exhaust pipe.

9. A device for controlling the maximum temperature of exposed surfaces on internal combustion engines according to claim 8, additionally including means for cooling at least a portion of the exhaust pipe connected to the enclosure.

10. A device for controlling the maximum temperature of exposed surfaces on internal combustion engines according to claim 9, wherein the means for cooling at least a portion of the exhaust pipe includes a jacket surrounding the exhaust pipe to form a cooling fluid circulation space surrounding the exhaust pipe.

11. A device for controlling the maximum temperature of exposed surfaces on internal combustion engines according to claim 10, additionally including a flexible connector connecting the exhaust pipe to the enclosure.

12. A device for controlling the maximum temperature of exposed surfaces on internal combustion engines according to claim 11, wherein the flexible connector connecting the exhaust pipe to the enclosure is cooled and includes a cooling fluid circulation space within the flexible connector.

13. A device for controlling the maximum temperature of exposed surfaces on internal combustion engines according to claim 12, wherein the flexible connector connecting the exhaust pipe to the enclosure comprises:
a flexible high temperature pipe having opposite pipe ends;
a flange sealingly connected to each of the opposite pipe ends and extending radially outwardly thereform to an outside perimeter edge;
an end sleeve sealingly connected to the outside perimeter edge of each flange to provide opposite end sleeves that extend from the flange toward the opposite sleeve; and
a flexible outside sleeve extending between and sealingly connected to each of the opposite end sleeves to form a flexible connector having a cooling fluid circulation space therein between the flexible high temperature pipe and the flexible outside sleeve.

14. A device for controlling the maximum temperature of exposed surfaces on internal combustion engines according to claim 1, additionally including an exhaust pipe connected to the enclosure and in flow communication with the exhaust manifold and associated components for discharging exhaust gas from the exhaust manifold and associated components onto the exhaust pipe.

15. A device for controlling the maximum temperature of exposed surfaces on internal combustion engines according to claim 14, additionally including means for cooling at least a portion of the exhaust pipe connected to the enclosure.

16. A device for controlling the maximum temperature of exposed surfaces on internal combustion engines according to claim 15, additionally including a flexible connector connecting the exhaust pipe to the enclosure.

17. A device for controlling the temperature of exposed internal combustion engine surfaces to maintain all exposed engine surfaces below a predetermined maximum temperature, comprising:
walls forming an enclosure for enclosing engine surfaces that normally reach temperatures above the predetermined maximum temperature during normal operation of the engine, at least some of said walls having exposed surfaces, and said enclosure being sized to provide an air space between the enclosed engine surfaces and the walls of the enclosure having exposed surfaces to slow heat transfer from the enclosed engine surfaces to the enclosure walls having exposed surfaces;
means for securing the enclosure around the engine surfaces to be enclosed; and
means for cooling the exposed surfaces of the enclosure walls having exposed surfaces.

18. A device for controlling the temperature of exposed internal combustion engine surfaces according to claim 17, wherein the walls forming the enclosure include a removable panel which can be removed to provide access to the enclosed engine surfaces.

19. A device for controlling the temperature of exposed internal combustion engine surfaces according to claim 17, wherein the means for cooling the exposed surfaces of the enclosure walls having exposed surfaces include fluid circulation spaces within the walls having exposed surfaces for circulation of cooling fluid, and an enclosure fluid circulation system for circulating cooling fluid through the fluid circulation spaces in the walls.

20. A method for controlling the temperature of exposed internal combustion engine surfaces to maintain all exposed engine surfaces below a predetermined maximum temperature, comprising the steps of:
identifying exposed engine surfaces that normally have a temperature above the predetermined maximum during normal operation of the engine;
enclosing the identified surfaces in an enclosure having walls, the surfaces of at least some of said walls being exposed surfaces, said enclosure sized to provide an air space between the enclosed engine surfaces and the walls of the enclosure having exposed surfaces to slow heat transfer from the enclosed engine surfaces to the enclosure walls having exposed surfaces, and
cooling the enclosure walls having exposed surfaces to maintain the exposed wall surfaces at a temperature below the predetermined maximum temperature.

21. A method for controlling the temperature of exposed internal combustion engine surfaces according to claim 20, wherein the step of cooling the enclosure walls having exposed surfaces to maintain the exposed wall surfaces at a temperature below the predetermined maximum temperature includes the step of circulating a cooling fluid through the walls having exposed surfaces to cool the exposed surfaces.

22. A method for controlling the temperature of exposed internal combustion engine surfaces according to claim 21, wherein the engine has an engine cooling system with engine cooling fluid and a radiator having a cooled cooling fluid outlet and a heated cooling fluid inlet, and wherein the step of circulating a cooling fluid through the enclosure walls having exposed surfaces to cool the exposed surfaces includes the step of withdrawing cooling fluid from the cooled cooling fluid outlet and adding cooling fluid after circulation through the walls having exposed surfaces to the heated cooling fluid inlet.

23. A method for controlling the temperature of exposed internal combustion engine surfaces according to claim 20, wherein the engine includes an exhaust manifold, wherein the step of identifying exposed engine surfaces that normally have a temperature above the predetermined maximum during normal operation of the engine identifies the exhaust manifold, and wherein the step of enclosing the identified surfaces in an enclosure includes the step of enclosing the exhaust manifold in an enclosure.

24. A method for controlling the temperature of exposed internal combustion engine surfaces according to claim 20, wherein the engine includes an exhaust manifold and a turbocharger, wherein the step of identifying exposed engine surfaces that normally have a temperature above the predetermined maximum during normal operation of the engine identifies the exhaust manifold and the turbocharger, and wherein the step of enclosing the identified surfaces in an enclosure includes the step of enclosing the exhaust manifold and turbocharger in an enclosure.

25. A cooled flexible connector for connecting flow lines carrying heated fluids comprising:
a flexible high temperature pipe having opposite pipe ends;
a flange sealingly connected to each of the opposite pipe ends and extending radially outwardly thereform to an outside perimeter edge;
an end sleeve sealingly connected to the outside perimeter edge of each flange to provide opposite end sleeves that extend from the flange toward the opposite sleeve; and
a flexible outside sleeve extending between and sealingly connected to each of the opposite end sleeves to form a flexible connector having a cooling fluid circulation space therein between the flexible high temperature pipe and the flexible outside sleeve.

26. A cooled flexible connector for connecting flow lines carrying heated fluids, according to claim 25, wherein the high temperature pipe has a length and a diameter and wherein the length of the high temperature pipe is at least two and one half times the diameter of the high temperature pipe.
